(19) United States
(12) Patent Application Publication
(10) Pub. No.: US 2022/0404651 A1
(43) Pub. Date: Dec. 22, 2022

(54) Optical Modulator and Related Apparatus

(71) Applicant: Huawei Technologies Co., Ltd., Shenzhen (CN)

(72) Inventors: Chengcheng Gui, Wuhan (CN); Yanbo Li, Dongguan (CN); Xiaolu Song, Shenzhen (CN)

(21) Appl. No.: 17/896,547

(22) Filed: Aug. 26, 2022

Related U.S. Application Data
(63) Continuation of application No. PCT/CN2021/076985, filed on Feb. 20, 2021.

(30) Foreign Application Priority Data
Feb. 29, 2020 (CN) 202010132612.1

(51) Int. Cl. G02F 1/035; H04B 10/516; H04B 10/50

(52) U.S. Cl. CPC G02F 1/035; H04B 10/516; H04B 10/501; G02F 2202/20

(57) ABSTRACT

An optical modulator includes a waveguide layer, an electro-optical material layer, and electrodes. The waveguide layer includes a sub-wavelength waveguide; the electro-optical material layer is disposed on a surface of the sub-wavelength waveguide, and the sub-wavelength waveguide is configured to diffuse a light field at the waveguide layer into the electro-optical material layer; the electrodes are disposed on a surface of the electro-optical material layer, and a connection line between the electrodes is parallel to a plane on which the electro-optical material layer is located, or the electrodes are disposed on two sides of the electro-optical material layer, and a connection line between the electrodes intersects with a plane on which the electro-optical material layer is located; and the electrodes are configured to apply an electrical signal to the electro-optical material layer.

### CROSS-REFERENCE TO RELATED APPLICATIONS

This application is a continuation of International Patent Application No. PCT/CN2021/076985, filed on Feb. 20, 2021, which claims priority to Chinese Patent Application No. 202010132612.1, filed on Feb. 29, 2020. The disclosures of the aforementioned applications are hereby incorporated by reference in their entireties.

### TECHNICAL FIELD

This disclosure relates to the field of optical communications technologies, and in particular, to an optical modulator and a related apparatus.

### BACKGROUND

An optical modulator is one of the most important integrated devices in an optoelectronic integrated circuit. In recent years, with emergence of artificial intelligence and big data computing, people's requirements for a communications capacity, bandwidth, and a rate have increased explosively, and the optical modulator has developed rapidly. The bandwidth and modulation efficiency are two important parameters for measuring device performance of the optical modulator.

A conventional optical modulator (for example, a silicon optical modulator) is limited by an electron migration rate, and a theoretical bandwidth limit of the conventional optical modulator is less than 70 gigahertz (GHz). An electro-optical material having a high electro-optical effect (for example, an organic polymer or a lithium niobate thin film) is used, to increase bandwidth of the optical modulator.

In the conventional technology, a common solution is to fill a waveguide slot with an organic polymer or to etch a waveguide layer on a lithium niobate thin film, so that a light field is limited within an electro-optical material. However, the waveguide slot has a small size, and it is very difficult to fill the waveguide slot with the organic polymer, and a physicochemical property of the lithium niobate thin film is very stable, and it is very difficult to etch the waveguide layer on the lithium niobate thin film. In the foregoing solution, there is a complex process, high preparation costs, and low practicality.

### SUMMARY

Embodiments of this disclosure provide an optical modulator and a related apparatus, to simplify a process, so as to reduce preparation costs and improve practicality of applying an electro-optical material to the optical modulator.

According to a first aspect, an embodiment of this disclosure provides an optical modulator. The optical modulator includes a waveguide layer, an electro-optical material layer, and electrodes. The waveguide layer includes a sub-wavelength waveguide, the electro-optical material layer is disposed on a surface of the sub-wavelength waveguide, and the sub-wavelength waveguide is configured to diffuse a light field at the waveguide layer into the electro-optical material layer, the electrodes are disposed on a surface of the electro-optical material layer, and a connection line between the electrodes is parallel to a plane on which the electro-optical material layer is located, or the electrodes are disposed on two sides of the electro-optical material layer, and a connection line between the electrodes intersects with a plane on which the electro-optical material layer is located, and the electrodes are configured to apply an electrical signal to the electro-optical material layer. A material of the waveguide layer includes silicon, silicon nitride, or group III-V materials. A material of the electro-optical material layer includes an organic polymer, a lithium tantalate thin film, a lithium niobate thin film, or a barium titanate thin film. A material of the electrodes includes graphene or a transparent conductive oxide.

According to a second aspect, an embodiment of this disclosure provides an optical module, including a light source, a drive apparatus, and the optical modulator according to any one of the first aspect and the specific implementations of the first aspect. The light source is configured to generate input light, and transmit the input light to a waveguide layer of the optical modulator through an optical fiber. The drive apparatus is configured to generate an electrical signal, and transmit the electrical signal to electrodes of the optical modulator through a circuit path. The optical modulator is configured to receive the input light and the electrical signal, and modulate the input light based on the electrical signal.

According to a third aspect, an embodiment of this disclosure provides a network device, including a wavelength division multiplexer/demultiplexer, a main board, and the optical module in the second aspect. The optical module is disposed on the main board. The wavelength division multiplexer/demultiplexer is disposed on the main board, the wavelength division multiplexer/demultiplexer is connected to the optical module through an optical fiber, and the wavelength division multiplexer/demultiplexer is configured to process wavelength division multiplexing/demultiplexing of an optical signal.

### BRIEF DESCRIPTION OF DRAWINGS

FIG. 1 is a schematic diagram of an application scenario according to an embodiment of this disclosure;

FIG. 2 is a schematic top view of a structure of an optical modulator according to an embodiment of this disclosure;

FIG. 3 is a schematic diagram of a structure of a sub-wavelength waveguide according to an embodiment of this disclosure;

FIG. 4 is a schematic diagram of another structure of a sub-wavelength waveguide according to an embodiment of this disclosure;

FIG. 5 is a schematic diagram of a structure of an optical modulator according to an embodiment of this disclosure;

FIG. 6 is a schematic diagram of another structure of an optical modulator according to an embodiment of this disclosure;

FIG. 7 is a schematic diagram of still another structure of an optical modulator according to an embodiment of this disclosure;

FIG. 8 is a schematic diagram of a simulation of a light field distribution according to an embodiment of this disclosure;

FIG. 9 is a schematic diagram of a simulation of another light field distribution according to an embodiment of this disclosure; and

FIG. 10 is a schematic diagram of a structure of a network device according to an embodiment of this disclosure.

### DESCRIPTION OF EMBODIMENTS

An embodiment of this disclosure provides an optical modulator. The optical modulator includes a waveguide layer, an electro-optical material layer, and electrodes. The waveguide layer includes a sub-wavelength waveguide. The electro-optical material layer is disposed on a surface of the sub-wavelength waveguide. An electro-optical material does not need to be further processed, and the sub-wavelength waveguide at the waveguide layer may be used to diffuse a light field at the waveguide layer into the electro-optical material layer. When bandwidth of the photoelectric modulator is increased, a process is simplified, preparation costs are reduced, and practicality of the optical modulator is improved.

The following describes embodiments of this disclosure with reference to the accompanying drawings. A person of ordinary skill in the art may learn that, with technology development and emergence of a new scenario, the technical solutions provided in embodiments of this disclosure are also applicable to resolving a similar technical problem.

In this disclosure, the terms “first”, “second”, and the like are intended to distinguish between similar objects but do not necessarily indicate a specific order or sequence. It should be understood that the terms used in such a way are interchangeable in proper circumstances, which is merely a discrimination manner that is used when objects having a same attribute are described in embodiments of this disclosure. In addition, the terms “include”, “contain” and any other variants mean to cover the non-exclusive inclusion, so that a process, method, system, product, or device that includes a series of units is not necessarily limited to those units, but may include other units not expressly listed or inherent to such a process, method, product, or device.

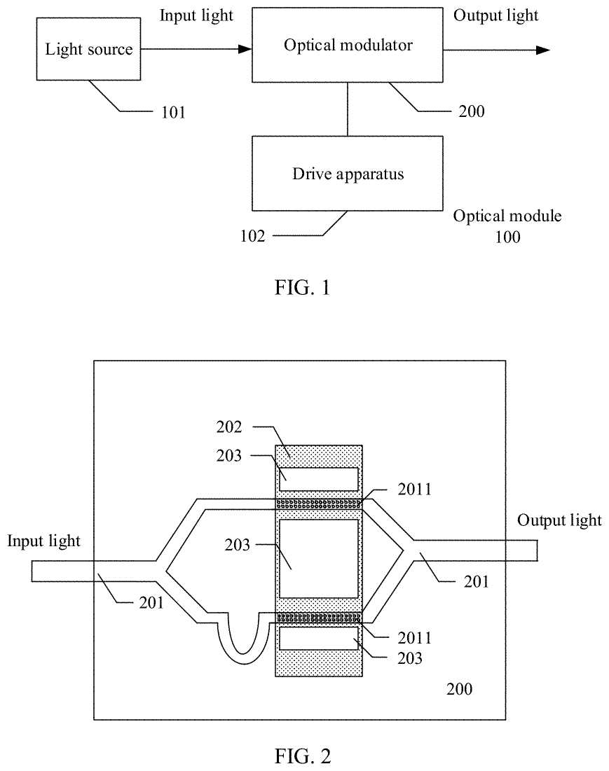

FIG. 1 is a schematic diagram of an application scenario according to an embodiment of this disclosure. FIG. 1 shows an optical module 100. An optical modulator 200 is provided in this embodiment of this disclosure may be applied to the optical module 100. As shown in FIG. 1, the optical module 100 further includes a light source 101 and a drive apparatus 102. The light source 101 is configured to generate input light. The input light is transmitted to the optical modulator 200 through an optical fiber. The drive apparatus 102 is configured to generate an electrical signal. The electrical signal is transmitted to the optical modulator 200 through a circuit path. The optical modulator 200 is configured to receive the input light and the electrical signal, and modulate the input light based on the electrical signal. The optical modulator 200 is further configured to transmit output light through the optical fiber.

It should be noted that a use scenario of the optical modulator provided in this disclosure is not limited to the optical module, but may be further applied to another optical system, for example, an optical coherent system (OCS).

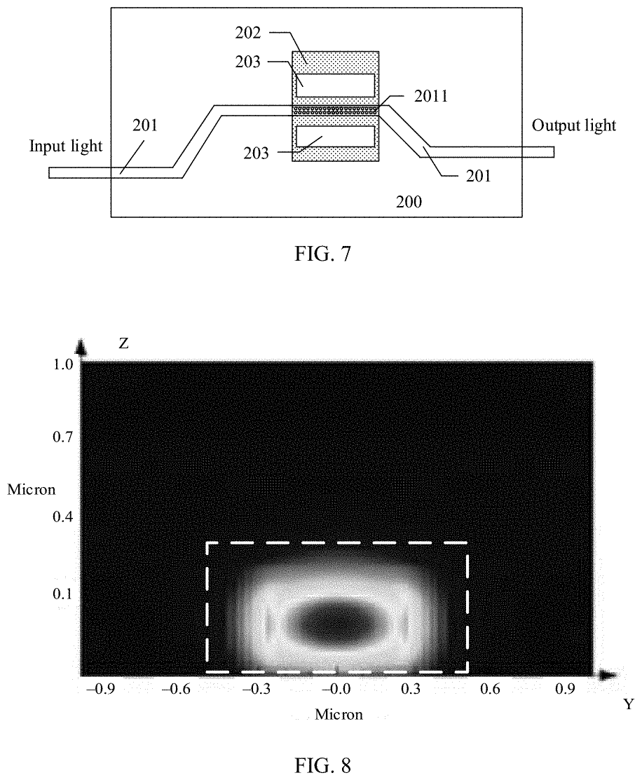

FIG. 2 is a schematic top view of a structure of an optical modulator 200 according to an embodiment of this disclosure. The optical modulator 200 includes a waveguide layer 201, an electro-optical material layer 202, and electrodes 203. The electrodes 203 include three electrodes. It should be understood that a quantity of electrodes may be set based on an actual requirement. For example, in another example shown in FIG. 7, there are two electrodes.

The waveguide layer 201 is disposed on a substrate. The substrate may be a semiconductor material such as silicon, germanium, or silicon dioxide, or may be an insulating material. This is not limited herein. The waveguide layer 201 is made of silicon, silicon nitride, or III-V materials. A related structure shown in FIG. 2 may be etched on the substrate in a manner such as a dry etching manner or a wet etching manner. The waveguide layer 201 includes an input end, a beam splitter, a sub-wavelength waveguide 2011, a beam combiner, and an output end. Light is emitted from a light source (for example, the light source is a laser), and enters the waveguide layer 201 of the optical modulator 200 through the input end. After passing through the beam splitter, the light is transmitted through two arms, and enters the sub-wavelength waveguide 2011.

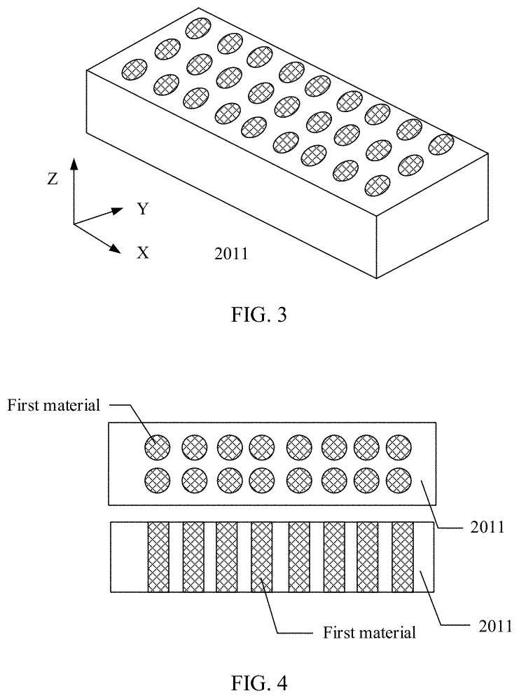

The sub-wavelength waveguide 2011 is of a periodic structure whose size is less than a wavelength of acting light (as shown in FIG. 3 and FIG. 4). A basic characteristic is as follows: When a light wave acts on a sub-wavelength structure, there is only zero-order reflection and projection diffraction, and a property of the sub-wavelength structure is similar to a property of a same homogeneous medium. A depth and a duty cycle of the sub-wavelength structure are adjusted, so that a related optical property such as reflectivity, a refractive index, or a transmittance of the sub-wavelength structure can be adjusted. In this embodiment of this disclosure, the waveguide layer 201 is etched with the sub-wavelength waveguide 2011. The electro-optical material layer 202 is disposed on a surface of the sub-wavelength waveguide 2011, and the sub-wavelength waveguide 2011 is used to diffuse a light field at the waveguide layer 201 into the electro-optical material layer 202. An electro-optical material has a characteristic of a high electro-optical effect, and the light field is modulated under a joint action of the electro-optical material and the electrodes 203, to increase bandwidth of the optical modulator 200.

As shown in FIG. 3 and FIG. 4, the sub-wavelength waveguide includes a plurality of trenches. A size (for example, a length, a width, and a depth of the trench) of the trench in the sub-wavelength waveguide 2011 and a duty cycle of the sub-wavelength waveguide 2011 (a ratio of a volume of the trench to a total volume of the sub-wavelength waveguide 2011) are adjusted, so that a refractive index of the sub-wavelength waveguide 2011 can be adjusted. Further, a structural parameter of a part that is of the sub-wavelength waveguide 2011 and that is close to the beam splitter is adjusted, so that the light field at the waveguide layer 201 can be diffused into the electro-optical material layer 202, and a structural parameter of a part that is of the sub-wavelength waveguide 2011 and that is close to the beam combiner is adjusted, so that the light field at the electro-optical material layer 202 can be diffused into the waveguide layer 201, and light can be transmitted to the beam combiner.

The sub-wavelength waveguide 2011 has a circular hole structure or a polygonal hole structure, for example, a rhombic hole structure, a rectangular hole structure, or an elliptic hole structure. This is not limited herein. FIG. 3 is a schematic diagram of a structure of a sub-wavelength waveguide 2011 according to an embodiment of this disclosure. FIG. 3 is used as an example. When the sub-wavelength waveguide 2011 is applied to the optical modulator 200, the electro-optical material layer 202 is disposed on an upper surface (namely, an upper surface in a Z-axis direction) of the sub-wavelength waveguide 2011.

FIG. 4 is a schematic diagram of another structure of a sub-wavelength waveguide 2011 according to an embodiment of this disclosure. An upper half part in FIG. 4 is a top view of the sub-wavelength waveguide 2011, and a lower half part is a cross-sectional view of the wavelength structure. The sub-wavelength waveguide 2011 is filled with a first material, and a refractive index of the first material is different from a refractive index of a material of the waveguide layer 201. The first material may be air, silicon dioxide, or another dielectric material that matches a refractive index of the electro-optical material. This is not limited herein. Further, the refractive index of the first material is related to a refractive index of the waveguide layer 201 and a refractive index of the electro-optical material layer 202. For example, when the refractive index of the waveguide layer 201 is greater than the refractive index of the electro-optical material layer 202, a refractive index of a dielectric material selected as the first material is small, or when the refractive index of the waveguide layer 201 is less than the refractive index of the electro-optical material layer 202, a refractive index of a dielectric material selected as the first material is large.

A material with a high electro-optical coefficient such as an organic polymer, a lithium tantalate thin film, a lithium niobate thin film, or a barium titanate thin film is used for the electro-optical material layer 202, to increase the bandwidth of the optical modulator 200. For example, the lithium niobate thin film is used for the electro-optical material layer 202, and the lithium niobate thin film is tiled on the surface of the sub-wavelength waveguide 2011 (for example, silicon) through bonding.

The electrodes 203 are disposed on a surface or two sides of the electro-optical material layer 202. The optical modulator 200 applies an electrical signal to the electro-optical material layer 202 through the electrodes 203. In a specific implementation, a material with high electrical conductivity and a small optical absorption loss, for example, graphene or a transparent conductive oxide (TCO), is used for the electrodes 203. A spacing between the electrodes 203 may be effectively reduced, to effectively reduce a half-wave voltage of a device, and reduce power consumption of the optical modulator 200. A metal material such as gold, silver, or copper may alternatively be used for the electrodes 203. This is not limited herein.

In an optional implementation, a size of the waveguide layer 201 is 500 nanometers to 800 nanometers, a size of the electro-optical material layer 202 is 1 micron to 5 microns, the sub-wavelength waveguide 2011 has a circular hole structure, and a size of the circular hole structure is 1 nanometer to 50 nanometers.

In this embodiment of this disclosure, the sub-wavelength waveguide at the waveguide layer is used to diffuse the light field at the waveguide layer into the electro-optical material layer, so that the electrodes can be used to modulate the light field by using the electro-optical material. Further, the sub-wavelength waveguide is used to change the refractive index of the waveguide layer, so that a difference between the refractive index of the waveguide layer and the refractive index of the electro-optical material layer becomes smaller, to diffuse the light field into the electro-optical material. The sub-wavelength waveguide is obtained through etching based on a characteristic that it is convenient to etch and process a common material of the waveguide layer such as silicon or silicon nitride. The electro-optical material layer is disposed on the surface of the sub-wavelength waveguide, the electro-optical material does not need to be further processed, and the sub-wavelength waveguide at the waveguide layer may also be used to diffuse the light field at the waveguide layer into the electro-optical material layer. When the bandwidth of the photoelectric modulator is increased, a process is simplified, preparation costs are reduced, and practicality of applying the electro-optical material to the optical modulator is improved. The material with high electrical conductivity and a small optical absorption loss is used for the electrodes. The spacing between the electrodes can be effectively reduced, to effectively reduce the half-wave voltage of the device, reduce an insertion loss, reduce power consumption of the optical modulator, and improve modulation efficiency of the optical modulator.

Based on the foregoing embodiment shown in FIG. 2 to FIG. 4, there may be two optional implementations of the optical modulator proposed in this embodiment of this disclosure, and the two optional implementations are separately described below.

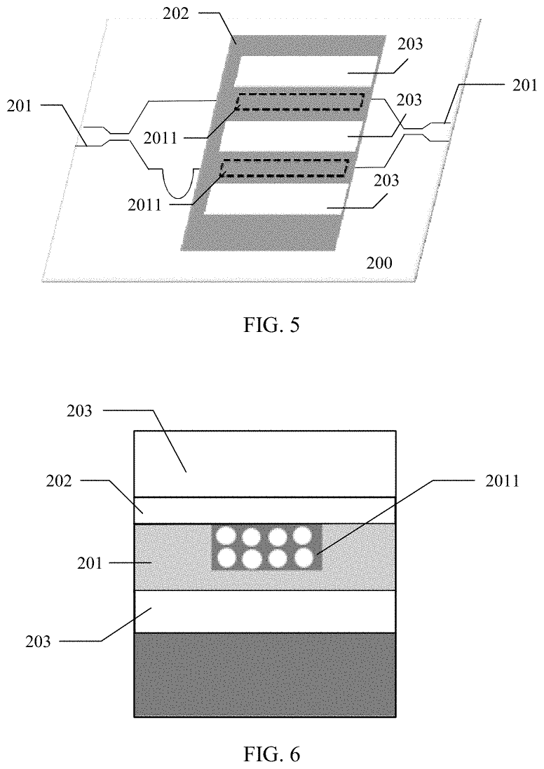

FIG. 5 is a schematic diagram of a structure of an optical modulator according to an embodiment of this disclosure. The optical modulator provided in this embodiment of this disclosure includes a waveguide layer 201, an electro-optical material layer 202, and electrodes 203. The waveguide layer 201 includes a sub-wavelength waveguide 2011. A structure of the optical modulator in FIG. 5 is similar to the structure of the optical modulator in FIG. 2. Further, the electrodes 203 are disposed on a surface of the electro-optical material layer 202, and a connection line between the electrodes 203 is parallel to a plane on which the electro-optical material layer 202 is located.

FIG. 6 is a schematic diagram of another structure of an optical modulator according to an embodiment of this disclosure. The optical modulator provided in this embodiment of this disclosure includes a waveguide layer 201, an electro-optical material layer 202, and electrodes 203. The waveguide layer 201 includes a sub-wavelength waveguide 2011. A difference between the structure of the optical modulator in FIG. 6 and the structure of the optical modulator in FIG. 2 lies in that in FIG. 6, a connection line between the electrodes 203 intersects a plane on which the electro-optical material layer 202 is located.

Based on the optical modulators shown in FIG. 5 and FIG. 6, in an optional implementation, the waveguide layer 201 is a silicon waveguide etched on a silicon-on-insulator (SOI) substrate. To fit the waveguide layer 201, a lithium niobate thin film may be selected for the electro-optical material layer 202. The lithium niobate thin film is tiled on a surface of the waveguide layer 201 through bonding. Optionally, the lithium niobate thin film may cover the waveguide layer 201, or may cover only the sub-wavelength waveguide 2011. The optical modulator 200 limits a light field within the electro-optical material layer 202 by using the sub-wavelength waveguide 2011. In this case, a transparent conductive oxide may be selected as a material of the electrodes 203.

Based on the optical modulators shown in FIG. 5 and FIG. 6, in an optional implementation, the waveguide layer 201 is a silicon waveguide etched on a silicon nitride substrate. An organic polymer may be selected for the electro-optical material layer 202. Graphene may be selected as the material of the electrodes 203.

The optical modulator provided in this disclosure may be an optical modulator with a single waveguide arm in addition to an optical modulator (for example, a waveguide layer including a beam splitter and a beam combiner) with two waveguide arms shown in FIG. 2 to FIG. 6. FIG. 7 is a schematic diagram of still another structure of an optical modulator according to an embodiment of this disclosure. In an optical modulator 200 shown in FIG. 7, a waveguide layer 201 does not include a beam splitter or a beam combiner, but includes only one waveguide. A structure and a composition of the optical modulator 200 are similar to a structure and a composition of the optical modulators shown in FIG. 2 to FIG. 7. Details are not described herein again.

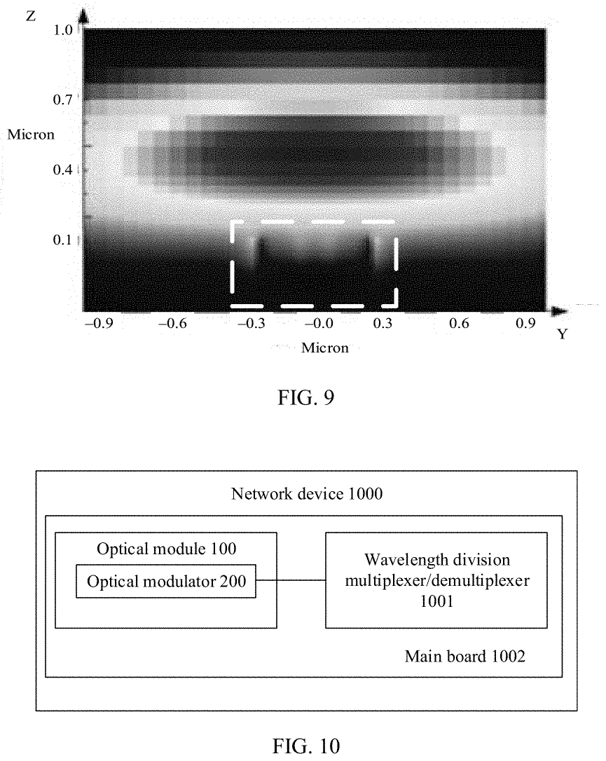

In this embodiment of this disclosure, a sub-wavelength waveguide is disposed at the waveguide layer, to change a refractive index of the waveguide layer, so as to diffuse a light field at the waveguide layer into a lithium niobate thin film material, and improve modulation efficiency. FIG. 8 is a schematic diagram of a simulation of a light field distribution according to an embodiment of this disclosure. FIG. 9 is a schematic diagram of a simulation of another light field distribution according to an embodiment of this disclosure. For example, as shown in FIG. 8, the light field distribution of the optical modulator provided in this embodiment of this disclosure is only in a white dashed frame region, and the white dashed frame region is a region in which a cross section of a waveguide layer 201 (not a sub-wavelength waveguide 2011) is located. A light field distribution of the sub-wavelength waveguide 2011 is shown in FIG. 9. In this case, a region in which a light field is located is at the electro-optical material layer 202. The sub-wavelength waveguide 2011 is used to diffuse the light field into the electro-optical material layer 202, to improve modulation efficiency of the optical modulator. Compared with modulation efficiency of a conventional optical modulator, modulation efficiency of the optical modulator provided in this embodiment of this disclosure is improved from 13.8 Vcm to 2.3 Vcm. Because the light field is limited within the electro-optical material layer, a device loss is further reduced, and a transmission loss is less than 0.5 decibels per centimeter (dB/cm). When a TCO material is used for the electrodes 203 of the optical modulator, the modulation efficiency is further increased to 0.7 Vcm. It should be noted that, this is only a possible simulation experiment result, and another simulation experiment result may also exist based on different arrangements of actual devices. This is not limited herein. The sub-wavelength waveguide is disposed in the waveguide layer, to change an equivalent refractive index of a material, so that the light field fully interacts with the electro-optical material layer. A material with a high electro-optical effect is used for the electro-optical material layer, to improve the modulation efficiency. For different electro-optical materials, different waveguide structures can be designed to match a refractive index of a material, so that the different waveguide structures can be compatible with the electro-optical materials with different refractive indices. The sub-wavelength waveguide is etched on the substrate, to be compatible with an existing etching process of the waveguide layer, to reduce process difficulty.

An optical module 100 provided in an embodiment of this disclosure includes a light source 101, a drive apparatus 102, and an optical modulator 200. The optical modulator 200 includes the optical modulator 200 shown in any one of the foregoing embodiments. A structure of the optical module is similar to a structure of the optical module shown in FIG. 1. Details are not described herein again.

As shown in FIG. 10, this embodiment further provides a network device 1000, including an optical module 100, a wavelength division multiplexer/demultiplexer 1001, and a main board 1002. The optical module 100 includes the optical modulator 200 shown in any one of the foregoing embodiments. The optical module 100 is disposed on the main board 1002. The wavelength division multiplexer/demultiplexer 1001 is disposed on the main board 1002. The optical modulator 200 in the optical module 100 is connected to the wavelength division multiplexer/demultiplexer 1001 through an optical fiber, and the optical fiber and the wavelength division multiplexer/demultiplexer 1001 are configured to process wavelength division multiplexing (WDM)/demultiplexing of optical signals with different wavelengths.

It should be noted that, for a specific structure and function of the optical modulator 200 included in the network device in this embodiment, refer to related content disclosed in the related embodiments related to the optical modulator 200. Details are not described herein again.

It should be understood that “an embodiment” or “one embodiment” mentioned in the entire specification means that particular features, structures, or characteristics related to the embodiment are included in at least one embodiment of this disclosure. Therefore, “in an embodiment” or “in one embodiment” appearing throughout the specification does not necessarily refer to a same embodiment. In addition, these particular features, structures, or characteristics may be combined in one or more embodiments by using any appropriate manner. It should be understood that sequence numbers of the foregoing processes do not mean execution sequences in various embodiments of this disclosure. The execution sequences of the processes should be determined based on functions and internal logic of the processes, and should not be construed as any limitation on the implementation processes of embodiments of this disclosure.

In summary, the foregoing descriptions are merely example embodiments of the technical solutions of this disclosure, but are not intended to limit the protection scope of this disclosure. Any modification, equivalent replacement, or improvement made without departing from the spirit and principle of this disclosure shall fall within the protection scope of this disclosure.

What is claimed is:

1. An optical modulator comprising:
a waveguide layer comprising a sub-wavelength waveguide, wherein the sub-wavelength waveguide comprises a first surface;
an electro-optical material layer disposed on the first surface and comprising a second surface and two first sides, wherein the sub-wavelength waveguide is configured to diffuse a first light field from the waveguide layer to the electro-optical material layer;
electrodes disposed on one of the second surface or the two first sides, wherein the electrodes are configured to apply an electrical signal to the electro-optical material layer; and
a connection line located between the electrodes that is:
parallel to a plane on which the electro-optical material layer is located when the electrodes are disposed on the second surface; and
intersect with the plane when the electrodes are disposed on the two first sides.

2. The optical modulator of claim 1, wherein the sub-wavelength waveguide further comprises two second sides, wherein the waveguide layer further comprises a beam splitter and a beam combiner disposed on the two second sides, wherein the beam splitter is configured to output a second light field, and wherein the sub-wavelength waveguide is further configured to:
diffuse, into the electro-optical material layer, the second light field; and
diffuse a third light field at the electro-optical material layer into the beam combiner.

3. The optical modulator of claim 1, wherein the waveguide layer comprises a single waveguide, and wherein the sub-wavelength waveguide is further configured to diffuse a second light field at the electro-optical material layer into the waveguide layer.

4. The optical modulator of claim 1, wherein the sub-wavelength waveguide has a circular hole structure, a strip structure, or a polygonal hole structure.

5. The optical modulator of claim 4, wherein the sub-wavelength waveguide is filled with a first material, and wherein a first refractive index of the first material is different from a second refractive index of a second material of the waveguide layer.

6. The optical modulator of claim 5, wherein the first material is air or silicon dioxide.

7. The optical modulator of claim 1, wherein a material of the waveguide layer comprises silicon, silicon nitride, or group III-V materials.

8. The optical modulator of claim 1, wherein a material of the electro-optical material layer comprises an organic polymer, a lithium tantalate thin film, a lithium niobate thin film, or a barium titanate thin film.

9. The optical modulator of claim 1, wherein a material of the electrodes comprises graphene or a transparent conductive oxide.

10. An optical system comprising:
a light source configured to:
generate an input light; and
transmit the input light;
a drive apparatus configured to:
generate an electrical signal; and
transmit the electrical signal;
an optical fiber;
a circuit path; and
an optical modulator coupled to the light source through the optical fiber, coupled to the drive apparatus through the circuit path, and comprising:
a waveguide layer comprising a sub-wavelength waveguide and configured to receive, through the optical fiber, the input light, wherein the sub-wavelength waveguide comprises a first surface;
an electro-optical material layer disposed on the first surface and comprising a second surface and two first sides;
electrodes disposed on one of the second surface or the two first sides and configured to:
receive, through the circuit path, the electrical signal; and
apply the electrical signal to the electro-optical material layer; and
a connection line located between the electrodes that is:
parallel to a plane on which the electro-optical material layer is located when the electrodes are disposed on the second surface; and
intersect with the plane when the electrodes are disposed on the two first sides,
wherein the optical modulator is configured to modulate the input light based on the electrical signal, and
wherein the sub-wavelength waveguide is configured to diffuse a first light field from the waveguide layer to the electro-optical material layer.

11. The optical system of claim 10, wherein the sub-wavelength waveguide further comprises two second sides, wherein the waveguide layer comprises a beam splitter and a beam combiner disposed on the two second sides, wherein the beam splitter is configured to output a second light field, and wherein the sub-wavelength waveguide is further configured to:
diffuse, into the electro-optical material layer, the second light field; and
diffuse a third light field at the electro-optical material layer into the beam combiner.

12. The optical system of claim 10, wherein the waveguide layer is a single waveguide, and wherein the sub-wavelength waveguide is further configured to diffuse a second light field at the electro-optical material layer into the waveguide layer.

13. The optical system of claim 10, wherein the sub-wavelength waveguide has a circular hole structure, a strip structure, or a polygonal hole structure.

14. The optical system of claim 13, wherein the sub-wavelength waveguide is filled with a first material, and wherein a first refractive index of the first material is different from a second refractive index of a second material of the waveguide layer.

15. The optical system of claim 14, wherein the first material is air or silicon dioxide.

16. The optical system of claim 10, wherein a material of the waveguide layer comprises silicon, silicon nitride, or III-V materials.

17. The optical system of claim 10, wherein a material of the electro-optical material layer comprises an organic polymer, a lithium tantalate thin film, a lithium niobate thin film, or a barium titanate thin film.

18. The optical system of claim 10, wherein a material of the electrodes comprises graphene or a transparent conductive oxide.

19. A network device comprising:
a main board;
a wavelength division multiplexer/demultiplexer disposed on the main board and configured to process multiplexing/demultiplexing of an optical signal;
a first optical fiber;
a second optical fiber; and
an optical system, disposed on the main board, coupled to the wavelength division multiplexer/demultiplexer through the first optical fiber, and comprising:
a light source configured to:
generate an input light; and
transmit the input light;
a drive apparatus configured to:
generate an electrical signal; and
transmit the electrical signal; and
an optical modulator coupled to the light source through the second optical fiber, coupled to the drive apparatus through a circuit path, and comprising:
a waveguide layer comprising a sub-wavelength waveguide and configured to receive, through the second optical fiber, the input light, wherein the sub-wavelength waveguide comprises a first surface;
an electro-optical material layer disposed on the first surface and comprising a second surface and two first sides;
electrodes disposed on one of the second surface or the two first sides and configured to:
receive, through the circuit path, the electrical signal; and
apply the electrical signal to the electro-optical material layer; and
a connection line located between the electrodes that is:
parallel to a plane on which the electro-optical material layer is located; and
intersect with the plane,
wherein the optical modulator is configured to modulate the input light based on the electrical signal, and
wherein the sub-wavelength waveguide is configured to diffuse a first light field from the waveguide layer to the electro-optical material layer.

20. The network device according to claim 19, wherein the sub-wavelength waveguide further comprises two second sides, wherein the waveguide layer comprises a beam splitter and a beam combiner disposed on the two second sides, wherein the beam splitter is configured to output a second light field, and wherein the sub-wavelength waveguide is further configured to:
diffuse, into the electro-optical material layer, the second light field; and
diffuse a third light field at the electro-optical material layer into the beam combiner.
